(19) United States
(12) Patent Application Publication
(10) Pub. No.: US 2020/0195604 A1
(43) Pub. Date: Jun. 18, 2020

(54) UNIFIED MESSAGING DELIVERY BASED ON ANALYSIS AND PREDICTIONS

(71) Applicant: Microsoft Technology Licensing, LLC, Redmond, WA (US)

(72) Inventors: Amer A. Hassan, Kirkland, WA (US); Roy D. Kuntz, Kirkland, WA (US); David Anthony Lickorish, Sammamish, WA (US)

(21) Appl. No.: 16/220,511

(22) Filed: Dec. 14, 2018

(51) Int. Cl. H04L 12/58; H04W 4/14

(52) U.S. Cl. CPC H04L 51/36; H04L 51/046; H04L 51/066; G06N 20/00; H04W 4/14; H04L 51/043; H04L 51/26

(57) ABSTRACT

Techniques for message transport and network type selection, provided in the context of electronic messaging sessions (e.g., instant messaging, chat, voice, email, SMS, etc.) occurring between users, are disclosed herein. In an example, a message processing system performs operations to: receive and process a message, addressed from a sender to a recipient in a messaging session; predict a delivery state or read result for the message, based on identified activity of the recipient, or additionally, context of the interaction between the sender and the recipient; select a communications transport mechanism for the message, based on the predicted delivery state or read result; and cause transmission of the message to the recipient using the selected communications transport mechanism. In further examples, the prediction is performed using a machine-learning trained model, or is assisted with profile information, rules, historical data, or ongoing monitoring or tracking data.

### BACKGROUND

With the widespread deployment of wireless networks and portable computing devices, a device user may possess and operate a computing device in a number of different settings and environments. For instance, a user may operate a notebook computer, tablet, smartphone, smartwatch, or other mobile computing device at an airport, home, restaurant, worksite, or many other private or public locations. Further, the expansion of the wireless network connectivity in all of these settings have enabled users to receive and transmit text, voice, and video messaging and consume digital content via a variety of types of devices.

The mobility of computing devices and the increased prevalence of wireless network connectivity and different device form factors has resulted in new and complex scenarios for user-to-user communication. In the past, a cellphone might be the only mobile device that a user would operate, whereas in today's settings, a user might receive communication requests on the same or different messaging services accessed via any of a smartphone, smartwatch, notebook, desktop, smart hub, etc. Also, while voice calls or text messages might have been the only communication services available for users of first-generation cellphones, modern devices utilize these and a variety of other digital and voice-over-IP services to connect with other users. As a result of the expansion of the number of device types and messaging services, and the many notifications that are presented on devices, many users may choose to simply ignore messaging alerts and may miss person-to-person messages and content.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts an example communications environment among multiple entities for messaging operations, according to various examples of the present disclosure.

FIG. 2 depicts an example sequence for exchanging communication messages between a sender and a recipient within a communication session, according to various examples of the present disclosure.

FIG. 3 depicts a sequence diagram of an example scenario for message processing of an initial message, according to various examples of the present disclosure.

FIG. 4 depicts a flowchart of a further scenario for message delivery handling, according to various examples of the present disclosure.

FIG. 5 depicts a sequence diagram of a further scenario for message processing of a response message, according to various examples of the present disclosure.

FIG. 6 depicts a flowchart of a method for message processing with a unified communications service, for handling communications between a sender and a recipient, according to various examples of the present disclosure.

FIG. 7 illustrates a schematic of operational and functional components used among devices and systems for implementing unified messaging delivery, according to various examples of the present disclosure.

FIG. 8 is a block diagram illustrating an example of a machine upon which one or more embodiments may be implemented.

### DETAILED DESCRIPTION

Disclosed in some examples are methods, systems, devices, and associated operations and functionality that enable messaging adaptation, to improve a method of electronic communication delivery, and to enable the delivery and presentation of messages that would otherwise be undelivered, unread, or not identified. The techniques discussed herein may be applicable to a number of types (e.g., formats, mediums, channels, etc.) of communication sessions, including but not limited to, voice, text, and video content, chats, audio or video conferences, group or person-to-person messaging, and like forms of communications and conversations, including those involving humans exclusively or with the addition of hots and automated agents.

In an example, a unified communication system operates to perform an evaluation of a state of the sender (e.g., the user or device initiating a message) and a recipient (e.g., the user or device addressed to receive or output the message). This evaluation determines messaging options, such as the format or delivery type of a message, based upon activity of one or both parties. For instance, this evaluation may include choosing between a cellular network short messaging service (SMS) or an intemet-based instant message (IM) delivery type, depending on what service is available to the recipient. The evaluation may also choose other messaging options or characteristics based on a connectivity state and context of one or both parties (e.g., connected to a cellular or Wi-Fi network only, location of the device, whether a device is in motion, etc.). In particular, this evaluation may be performed to increase the chances that a particular message will be successfully delivered to a user device, read by the user (or, displayed or output), or that the message will receive an acknowledgement or response.

In specific examples, the unified communication system may perform message translation to convert, transcode, translate, or adapt the message from one message type (e.g., format, protocol, transport mechanism, etc.) to another. Thus, whether the sender initially sends a message using IM or SMS, the communication system decides the best delivery option to the recipient, based on an activity state, connectivity state, preferences, and other relevant information. As a basic scenario, this may involve considering a state of connectivity for the recipient: if the recipient has a cellular connection but no data connection, the message may be delivered via SMS; if the recipient has a data connection, the message may be delivered as an IM.

In contrast to these considerations, many types of messages and messaging requests are often attempted to recipient devices, regardless of connectivity or activity states of either the sender or recipient, leading to messages being queued, delayed, ignored, or even undelivered. The present techniques may apply rules, logic, and operate machine learning models that consider relevant information to predict an optimal message type and send the message using this predicted message type. As other specific examples, the information that is considered may include the ongoing activity being performed by the recipient user on the delivery device (e.g., whether the user has logged into the messaging service, has set an away or do-not disturb status, is participating in a phone call or viewing a video or presentation, has a scheduled meeting, is typing another message or using a business productivity application, etc.). Both client-side and back-end network information may be considered with the prediction, including the use of historical, recent, or predicted future activity data.

Use of the present techniques may provide a number of improvements and efficiencies in communications systems, in addition to the clear benefits of delivering timely person-to-person communications. First, the techniques may be utilized to reduce the incidence of lost, delayed, or re-transmitted messages via message communication mediums that are not available for use, thus saving bandwidth and processing resources on client and server computing devices. Second, the techniques may improve network quality of service, to increase the number of successfully delivered messages, and the timing in which such messages are processed and delivered. Third, the techniques may be utilized to provide effective improvements in graphical user interfaces and operational software, in both messaging or communication platforms and in other software applications and functions tied to such platforms. The present techniques thus provide technical solutions and benefits that are applicable to enhance network usability and mobility, networking performance and capabilities, and the operation of client devices and user interfaces. These and other benefits will be apparent from the following examples and drawings.

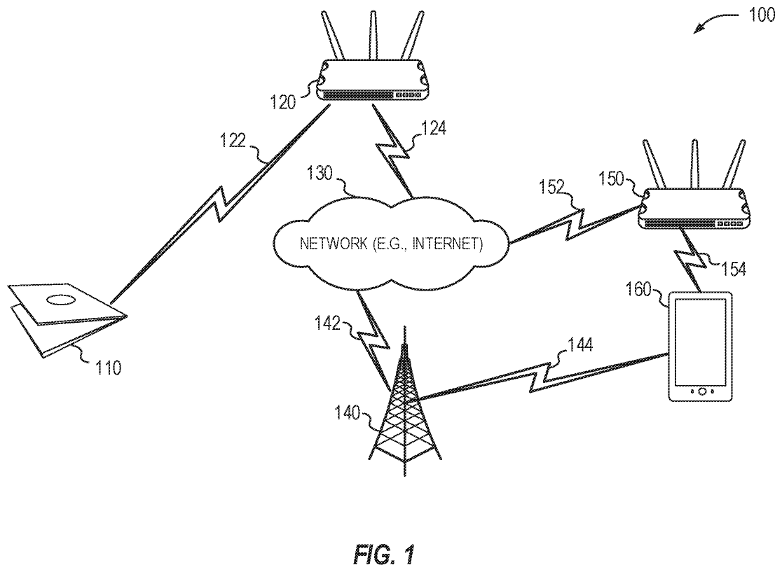

FIG. 1 illustrates an example communications environment 100 among multiple entities for messaging operations, according to some examples of the present disclosure. Computing device 110, shown as a notebook computer, and computing device 160, shown as a cellular telephone, are portable computing devices capable of operating at different locations. Specifically, devices 110, 160 may be moved among different locations of a corporate, personal, or other network deployment. This network is provided by various network access equipment, shown as a wireless local area access point 120, 150 (e.g., from each access point establishing an IEEE 802.11 Wi-Fi network), and a wireless wide area access point 140 (e.g., from a base station that establishes a 4G/LTE voice and data network).

In an example, the devices 110, 160 are capable of exchanging messaging data with each other in one or more messaging sessions, through connections 122, 124, 142, 144, 152, 154 through a wide area network (e.g., the Internet, a private telecommunications network, etc.). Thus, in some scenarios, the device 110 may operate as a sender of messaging data to the device 160 operating as a recipient via the network 130; in the same session, or in other sessions, the device 160 may operate as a sender of messaging data to the device 110 operating as a recipient via the network 130. The session may be ongoing, over a period of time with one or more uses, or may be stateless.

The mobility and network coverage changes that may occur from usage of either computing device may lead to complex communication scenarios involving the device. For instance, if the device 160 moves out of coverage range of the data network provided by WLAN access point 150, the device 160 may then rely exclusively on the data network provided by the cellular access point 140 (or, vice versa). Further, there may be some messaging services, such as video conferencing, which are available when the device 160 is connected to a higher-speed WLAN connection but not when the device is exclusively connected to a lower-speed WLAN connection. In still other scenarios, the device 160 is connected to multiple networks (e.g., via dual radios) but the device may prefer or require use of one network in lieu of the other network (as a result of data usage, billing, network connection quality, preferences, company policies, etc.). The presently described messaging service includes configuration capabilities to address these and other conditions.

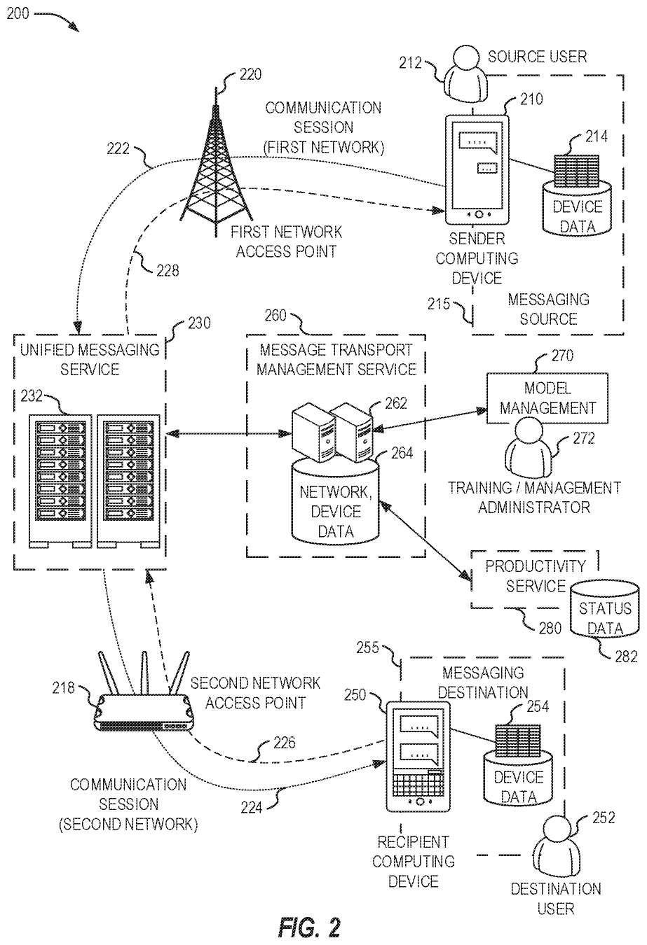

Turning now to FIG. 2, an example sequence 200 of messaging is illustrated, performed with a communication session between a sender computing device 210 at a messaging source 215 and a recipient computing device 250 at a messaging destination 255 according to various examples of the present disclosure. The operations are further shown as being coordinated via a unified messaging service 230, message transport management service 260, and other services and functionality discussed below.

The sender computing device 210 is operated by a source user 212 (e.g., a first human user) at the messaging source 215, which uses one or more software applications (e.g., IM programs, call software, video conferencing extensions, messaging clients, etc.) to transmit a message to the recipient via a communication session connection 222 to the unified messaging service 230 (e.g., via a first network connection established with first network access point 220). The messaging data is then communicated from the unified messaging service 230, via the communication session connection 224, to the recipient computing device 250 at the messaging destination 255 (e.g., via a second network connection established with the second network access point 218).

The unified messaging service 230 includes processing hardware 232 (e.g., servers) to control the type of messaging service that is invoked. In the configuration of FIG. 2, the determination and evaluation of the type of messaging service that is utilized is enacted through the message transport management service 260. This management service implements logic to determine what messaging type (or network protocol, or format, etc.) should be used for the communication session to communicate the messaging data to the recipient computing device 250. In this manner, the unified messaging service 230 identifies one or more aspects of the communication session to effectively identify a delivery or read state (e.g., read result, delivery result, response result) for a particular message, set of messages, messaging session, or communication configuration.

The message transport management service 260 analyzes factors such as the type of the messaging, the origin or destination of the messaging, the context and activity of the recipient, or the like, to predict the delivery or read state of the message or messaging session. In an example, the message transport management service 260 uses processing hardware 262 and stored data 264 to operate an artificial intelligence model (e.g., machine learning classifier, neural network, etc.) which performs inferences or classifications on data relating to the communication session, the participants of the session, etc. These models may be designed and trained to identify the situations and scenarios in which the destination user 252 is likely to use the recipient computing device 250 to accept, read, or respond to the message. This prediction may be binary in nature or may provide a scaled value such as a time measurement (e.g., associated with an objective to minimize the amount of time that the destination user 252 takes to responds to the message).

In an example, the network and device data 264 may include collected historical or real-time data relating to the messaging source 215, the messaging destination 255, or third parties. This data may accompany the use of device data 214, 254 which is collected before or during the communication session at the respective devices 210, 250. A model management service 270 may be used by a training or management administrator 272 (e.g., an administrative user) to modify the execution or deployment of the models, the types of the data 264 that is evaluated, the settings of the message transport management service 260, and the like. Other settings and model parameters may also be accomplished by the administrator 272. The message transport management service 260 may also enact various privacy controls and measures, such as those which anonymize data, or provide an opt-out for certain types of tracking.

The network and device data 264 may also be based on status data 282 or other information being collected and produced as part of a productivity service 280 or like third-party application service. For instance, the productivity service 280 may host or coordinate the use of business applications, and be aware of the status of a user's calendar, active work project, etc.

In a specific deployment, the unified messaging service 230 and the message transport management service 260 may be implemented within a cloud-based application service, such as in a business productivity platform which hosts or coordinates multiple types of multi-user productivity applications. The business productivity platform, for example, may host or coordinate different applications (e.g., word processing, spreadsheets, teleconferencing, business intelligence, etc.) which can easily determine whether a particular user is inactive, whether the user is actively using another app, whether the user is participating in a meeting, etc. For instance, if the user is in a meeting and is not active on their computer, the user is unlikely to see a desktop IM, so the model may determine that a SMS is more likely to be read and responded to.

Based on the analysis performed by the message transport management service, the message provided by the communication session connection 222 may be converted to another type of message (or specifically, a different type of message transport). This may be in the basic form of transcoding or converting a cellular network-based SMS message to an IP-based IM message, or vice versa. However, more complex translations and changes in messaging routing, delivery options, and adaptation may also be possible. Upon conversion of the message, the message is then delivered to the recipient computing device 250 via a communication session connection 224 over the second network.

Finally, FIG. 2 also shows a communication session connection 226 from the messaging destination 255 to the unified messaging service 230, and a communication session connection 228 from the unified messaging service 230 to the sender computing device 210. These connections 226, 228 may allow the exchange of a return message, or real-time data provided in response (e.g., in an audio or voice call). Further, although the connections 222, 224, and 226, 228 are depicted as separate connections, it will be understood that a two-way (duplex) communication session connection may also be established.

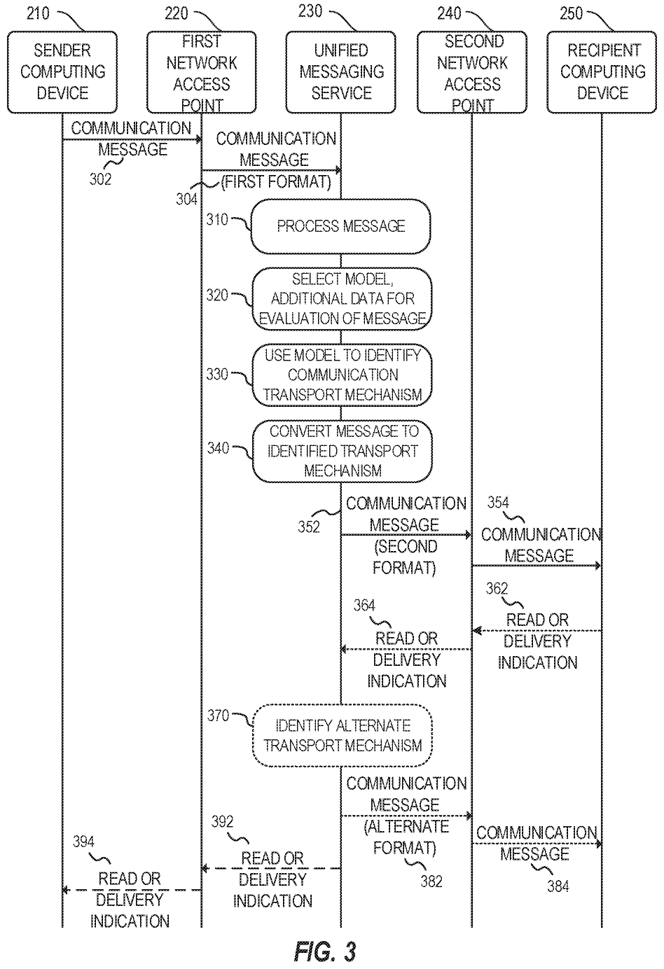

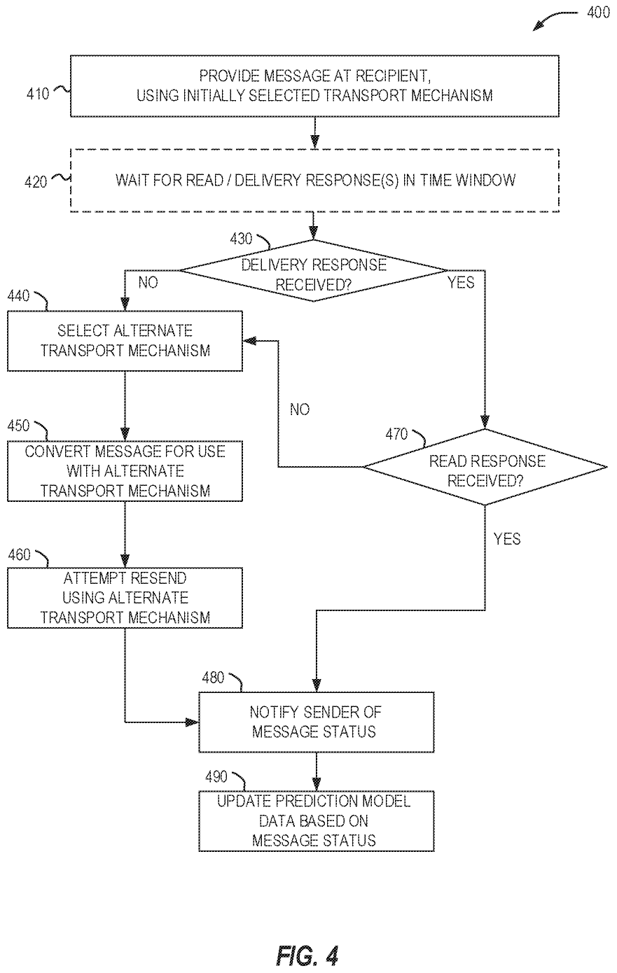

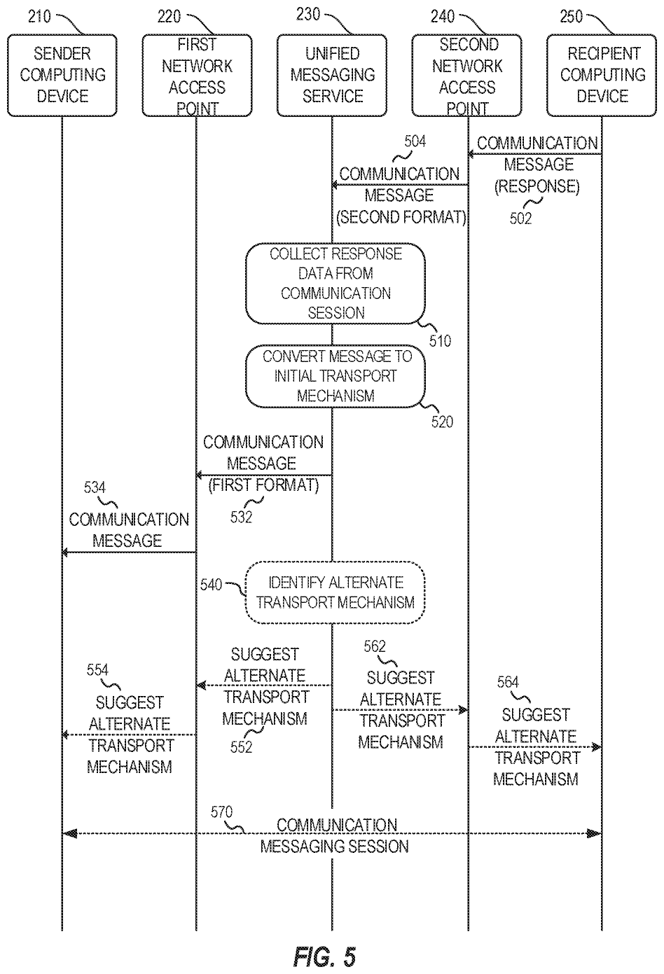

FIGS. 3-5 describe additional operational sequences for performing the message processing operations depicted in FIG. 2, for communication message handling (FIG. 3), message read or delivery status handling (FIG. 4), and communication message response handling (FIG. 5). Each of the methods of FIGS. 3-5 may adapt to different amounts of information available within the overall system, such as different status, activity, or context information being collected for the recipient, the recipient's computing device, and related applications. It will be understood, however, that different message processing scenarios may involve modifications or additions to the depicted operations.

FIG. 3 first provides a sequence diagram of messaging, as a communication message 302 is communicated from the sender computing device 210 to the first network access point 220, and then as a communication message 304 in a first format communicated to the unified messaging service 230. This message may be provided directly to the unified messaging service 230, or first to a proprietary messaging service (not shown) which passes the message to the unified messaging service 230.

The unified messaging service 230 performs operations to process the communication message (operation 310) (e.g., extract or identify relevant data fields), and then select a model (e.g., an AI model) and additional data for the evaluation of the communication message (operation 320), The additional data may be context or activity data for recipient devices being tracked by the unified messaging service 230; the additional data may be provided by a third party regarding the state of the recipient, recipient device, conditions related to the recipient, or the like. In an example, the context may be determined based on relationships or activities involving the parties (e.g., recurring meetings, calendar events), including work, organization, familial, or social relationships (boss, subordinate, executive, so on). In an example, the model may be customized, trained, or re-trained for use with a specific user or set of users; also in an example, the same model is used in many different settings, but provides customization based on the input parameters.

The unified messaging service 230 uses the model to identify another communication transport mechanism (operation 330) for the subject message. The unified messaging service 230 then performs operations to convert the message to the different communication transport mechanism (operation 340), and communicate this message, now in a second format, via a communication message 352 to the second network access point 240, after which the communication message 354 may be further communicated to the recipient computing device 250. A read or delivery indication (or a read and delivery indication) may be communicated via messages 362, 364, from the recipient computing device 250, via the second network access point 240, which provides a status of the message for further use by the unified messaging service 230,

Further optional processing may be implemented in the event that the read or delivery indication indicates a failure, delay, or other identifiable condition. This operational processing may include identifying an alternate transport mechanism (operation 370), which may even include the original message format. The identification of the alternate transport mechanism may include the selection and use of the model (in a similar manner as discussed with operations 320 and 330, above), and the conversion of the message to the alternate transport mechanism (in a similar manner as discussed with operation 370, above) while considering the read or delivery state. The use of an alternate transport mechanism may include the communication of the communication in an alternate format, via a communication message 382 to the second network access point 240, and via the communication message 384.

Finally, in some examples, an indication or status of the message read or delivery state may be conveyed back to the original sending device or third parties. This may be in the form of a read or delivery indication conveyed via status messages 392 and 394, provided from the unified messaging service to the sender computing device 210 via the first network access point. Although not shown, additional use cases may be adapted to handle other types of error processing, human involvement (e.g., canceling or recalling a message), or other conditions and rules.

FIG. 4 provides a flowchart with more detail on an example error handling sequence, from the perspective of the interaction from the unified communication service to the recipient computing device. As shown, the flowchart 400 includes operations to provide a message to a recipient (operation 410), with use of an initially selected transport mechanism (e.g., selected with a prediction model at the unified communication service, as discussed above). The unified communication system then begins a delay period (wait) for one or more read or delivery responses within a defined time window (operation 420), to identify whether the message may require a redelivery.

Based on an evaluation of whether a delivery response is received from a recipient device (determination 430), further read response processing (determination 470) is performed if the delivery response is received. If the delivery response is not received, an operation sequence is performed to select an alternate transport mechanism (operation 440), convert a message for use with an alternate transport mechanism (operation 450), and attempt a resend to the recipient computing device using the alternate transport mechanism (operation 460). The read response processing (determination 470) in turn will perform the alternate transport operations (operations 440-470) if no read response is received (e.g., received in the period of time, before another event occurs. etc.).

In either scenario, the delivery and read response may he followed by a notification, provided from the unified messaging system to the sender, regarding the message status (operation 480). This may include the indication of a read status receipt, a delivery status receipt, an indication of which transport was used, etc. Additional operations at the unified communication service may use the messaging outcome, or an aggregate set of outcomes, to update prediction model data (operation 490), retrain the model, etc.

FIG. 5 provides a further sequence diagram of messaging, as a response communication message 502. (e.g., a response to the message communicated in the sequence of FIG. 3) is communicated from the recipient computing device 250 to the second network access point 240, and then as a communication message 504 in a format used by the recipient computing device 250 (e.g., the “second format” used in FIG. 3) communicated to the unified messaging service 230. This response may also be used to negotiate another or an alternate transport mechanism, as discussed below.

In an example, the response processing performed by the unified messaging service 230 includes collecting response data from the communication session (operation 510), and converting the message into a format usable with the initial transport mechanism used by the sender computing device 210 (operation 520). Additional operations not shown may include notifying the sender of the change in the transport mechanism, asking for a switch in the transport mechanism, or using a model to determine an appropriate format for response. After conversion to the appropriate transport mechanism, the communication message is provided to the first network access point 220 and the sender computing device 210, using the communication messages 532, 534 in the initial format (e.g., the first format used by the sender computing device).

In an optional example, the unified messaging service 230 may attempt to coordinate use of an alternate transport mechanism, such as a mechanism that is compatible and usable by both devices 210, 250. This may be performed by operations of the unified messaging service 230 that identify an alternate transport mechanism (operation 540), using messages 552, 554 to the sender computing device 210 and messages 562, 564 to the recipient computing device 250 that suggest an alternate transport mechanism. The unified messaging service 230 may then coordinate the use of this alternate transport mechanism in a communication messaging session 570 (e.g., the same session transitioned to the common transport, mechanism, or a new session)

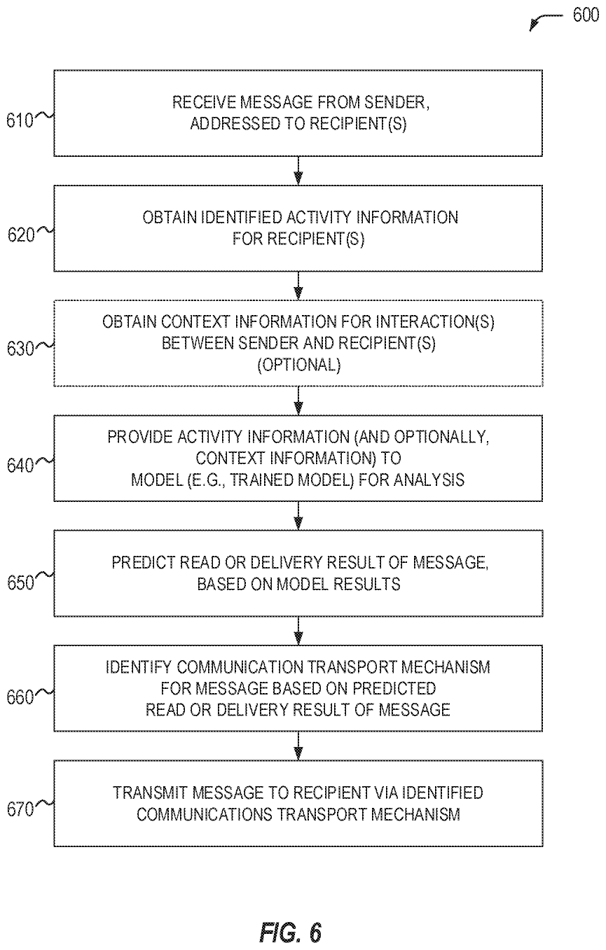

FIG. 6 includes a flowchart 600 with a sequential list of operations used for processing and communicating message, from a perspective of a communications service (e.g., a unified communications service operated by a service provider). The flowchart 600 of FIG. 6 commences with operation 610 of receiving a message from a sender, which is addressed to one or more recipients in a messaging session between the sender and the recipient(s). As referenced in the examples above, this message may be a text, voice, or video message, sent from among any number of communication service types.

The receipt of the message is followed by processing of the message, in the form of obtaining identifiable activity information for the recipient(s), at operation 620, and optionally, obtaining context information for interactions between the sender and the recipient, at operation 630. Such activity information may include data indicating availability to receive a communication via different communication transport mechanisms, and such context information may include data indicating a context of interaction between the sender and the recipient. For instance, the identified activity of the recipient may be determined from a scheduled event, participation in a meeting, participation in a call (such as a conference call), a working schedule, active operation of a software application, or a state of inactivity on a computing system the context of the context of the interaction may be indicated from: a defined relationship between the sender and the recipient, a duration of the messaging session, a previous messaging session between the sender and the recipient, or participation in a common event by the sender and the recipient. Other identified activity and context information may relate to the connectivity state of the device (such as having limited or no data coverage, but coverage via another network such as SMS).

The flowchart 600 of FIG. 6 continues by providing activity information, and optionally context information, to a model for analysis in operation 640. The model considers this information to predict a read or delivery result of the message, using one or more communication transport mechanisms, in operation 650. For instance, the read result which is predicted may correspond to a likelihood that the message is received and read by the recipient within a predefined time period.

In specific examples, the model that is utilized is a trained machine learning or neural network model, which identifies a read result of the message based on analysis of the activity of the recipient and a context of interaction related to the activity being provided as inputs to the model. For instance, a machine learning model may be trained to classify the read result of the message based on responses provided to messages for recipients and messaging sessions having corresponding activities and contexts.

In addition to the operations in 610-670, the communications transport mechanism may be based on additional selection criteria or evaluations. For example, the selected communications transport mechanism may be additionally based on a profile or rules corresponding to the sender or recipient. Such a profile may provide rules, conditions, or constraints for use of the communications transport mechanism.

In further examples, the operations 610-670 are performed by unified communications system allowing communications among multiple types of communications transport mechanisms with multiple types of messages. The unified communications system may provide the functionality of the operations 610-670 as part of messaging service for communications among a plurality of users including the sender and the recipient(s), but may include a variety of other capabilities and functions not discussed. In specific examples, the unified communications system is designed to provide communications among: an instant messaging service, a chat service, an email service, and a short messaging service (SMS) network service.

In further examples, prior to transmitting the message via the identified communications transport mechanism, the message is converted for use from a first message format compliant with the first communications transport mechanism to a second message format compliant with the second communications transport mechanism. This may include conversion for a format or transport mechanism usable with a Wi-Fi data network (e.g., internet-based instant messaging) to a format or transport mechanism usable with a cellular phone data network (e.g., SMS messaging). The operations may also involve conversion to another message format or type entirely (e.g., to a voicemail, to an email, etc.).

Other operations may logically follow the operations 610-670. For example, in the event that a subsequent message is received, addressed to the recipient from the sender, an updated read result of the subsequent message may be predicted. This prediction may be based on an updated activity of the recipient and an updated context of interaction between the sender and the recipient. This updated context may occur from the subsequent message and a response to the transmitting of the message. Before sending the subsequent message to the recipient, another communications transport mechanism may be selected. As an example, consider a scenario where an SMS is identified as the communications transport mechanism, because a prediction determines that a recipient is unlikely to quickly respond. However, if the recipient does respond quickly, the communication session may transition over to an IM session.

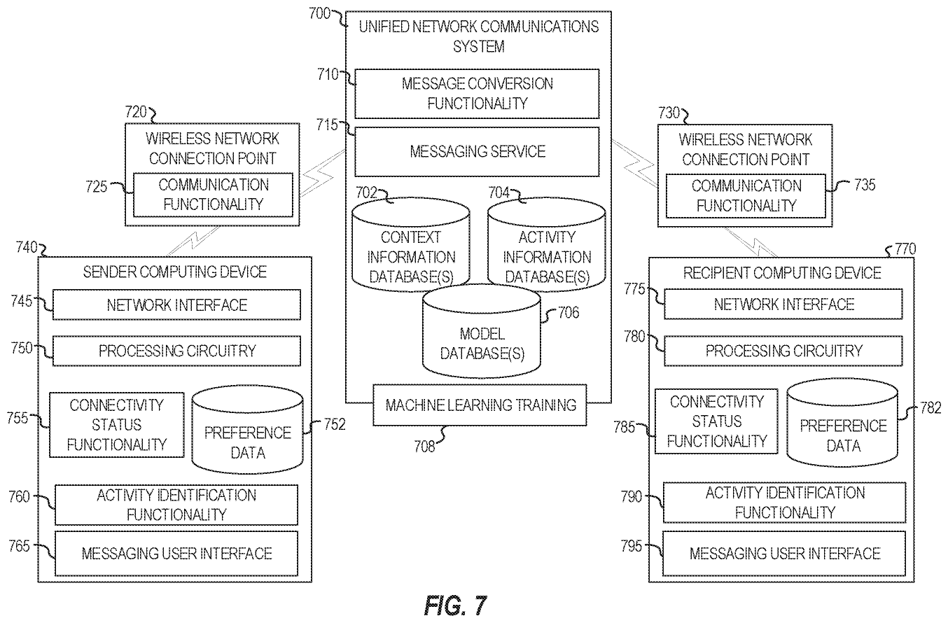

FIG. 7 illustrates a schematic of operational and functional components used among devices and systems to implement the presently disclosed techniques. These components include a unified network communications system 700, a sender computing device 740, a recipient computing device 770, wireless network connection points 720, 730, and various sub-components that are included or associated with the message service functionality discussed herein.

The unified network communication system 700 may be an example of a server that implements any of the messaging handling, transmission, delivery, or coordinating services or features discussed herein. The sender computing device 740 may be an example of a computing device operating as a server to provide at least an initial message, but which may also operate in a client role as a recipient. The recipient computing device 770 may be an example of a computing device operating as a client to receive at least an initial message, but which may also serve in a server role as a sender. The wireless network connection points 720, 730 may be an example of the wireless network equipment (access points, base stations, etc.) discussed herein, but may also involve the use of bridges, gateways, in the form of wired or wireless networking hardware.

The components shown in FIG. 7 may be embodied or implemented in hardware, software, or any combination thereof. The functionality of each component is one example arrangement of functionality and one of ordinary skill with the benefit of the present disclosure will appreciate that other organizations are possible. For example, one or more of the functions of one or more service components of the unified network communications system 700 may be distributed among other components or systems. Likewise, one or more of the computing device components may be distributed into other configurations or among multiple systems.

The computing devices 740, 770 may respectively include a messaging user interface 765, 795. The user interfaces 765, 795 provides operation of messaging functionality, such as through text, voice, or video mediums (e.g., via VoIP software or hardware, audio processing hardware, videoconferencing software) used to receive inputs and provide outputs in calls, chats, or other aspects of human-to-human or human-to-machine communications. The computing devices may further include software or configured hardware in the form of connectivity status functionality 755, 785, activity identification functionality 760, 790, and preference data 752, 782, which is used to collect, track, persist, and communicate characteristics of the respective devices related to connectivity status, activity, and preferences. As discussed above, the relevant status, activity, or preference information for the respective devices may be used by the unified network communications system 700 and applied models to predict or determine which message format, transport, type, etc. is most appropriate for communications.

The computing devices 740, 770 may be embodied in the form of a smartphone, tablet, personal computer, smart speaker or communication hub, vehicle, etc. These devices may respectively include processing circuitry 750, 780 to execute instructions and implement the functionality 755, 760, 765, 785, 790, 795, and a network interface 745, 775 having software and/or hardware components to enable the computing device to associate, authenticate, and connect to a wireless network (e.g., via respective connection points 720, 730). The network interfaces 745, 775 may implement network stacks, such as Transmission Control Protocol (TCP), Internet Protocol, one or more protocol layers specified by an 802.11 family of standards promulgated by the Institute for Electrical and Electronics Engineers (IEEE) (e.g., 802,11n or 802.11ac), 3GPP standards (e.g., 4G/LTE), and the like. The computing devices 740, 770 may also include other network interfaces for communicating via other types of wired or wireless networks.

The wireless network connection points 720, 730 in FIG. 7 are depicted as including communications functionality 725, 735 (e.g., hardware and software to establish connections via network protocols, enable mobility, etc.). The communications functionality 725, 735 may facilitate respective connections with client devices and the establishment of local and wide area network capabilities, such as using an IEEE 802.11 protocol. In other examples, the wireless network connection point may be part of a 3G, 4G/LTE, or 5G cellular network, or an equivalent wireless wide area network. However, as referenced above, in other examples, a wired connection may be used between one or both of the computing devices) and the communications system 700, among other systems in FIG. 7.

The unified network communications system 700 is depicted in FIG. 7 as including message conversion functionality 710, a messaging service 715, operating in connection with a context information database 702, an activity information database 704, and a model database 706. The databases 702, 704 may implement storage, tracking, and analysis of context and activity data relevant to the respective devices, and the database 706 may maintain a working copy or version of a model (e.g., artificial intelligence model) used for the data analysis. The system 700 may further integrate with machine learning training functionality 708 which updates, changes, or implemented different models for use with the prediction model operations discussed herein.

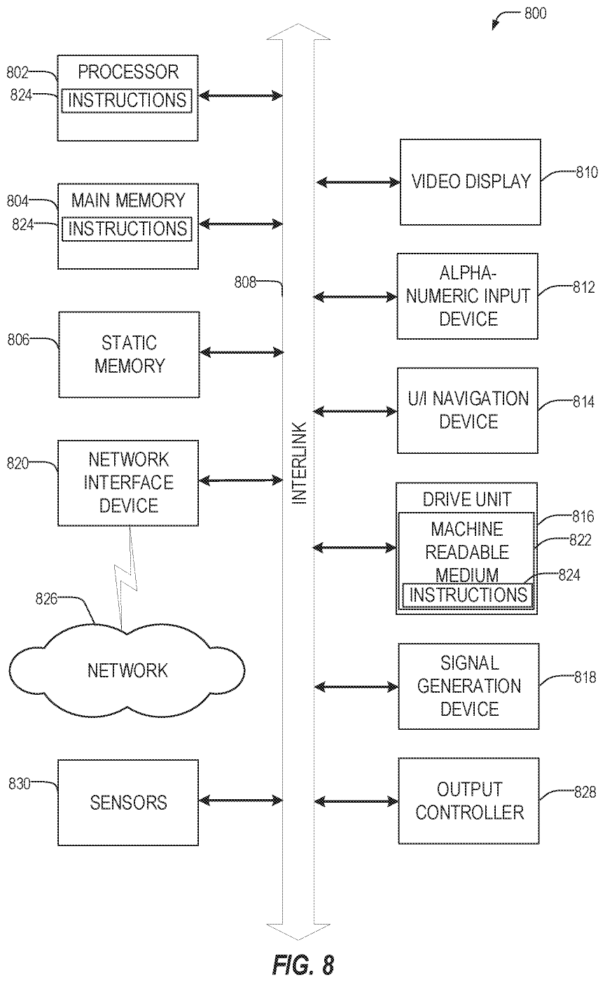

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments, in an example, the machine 800 may act as a peer machine in peer-to-peer (P2P) (or other distributed) network environment. The machine 800 may be a computing device such as a personal computer (PC), a tablet PC, a personal digital assistant (PDA), a mobile telephone, a cloud-based or networked server, a virtualized server, a smart phone, a web appliance, a network router, an access point, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations. Machine 800 or a variant thereof may implement the devices and platforms 110, 150, 160, 210, 250, 230, 260, 270 of FIGS. 1 and 2, the operations provided by the methods of FIGS. 3-6, or any of the systems and devices 700, 740, 770, as referenced in FIG. 7.

Examples, as described herein, may include, or may operate on, logic or a number of components, modules, or mechanisms (hereinafter “components”). Such components are tangible entities (e,g., hardware) capable of performing specified operations and may be configured or arranged in a certain manner. In an example, circuits or circuitry may be arranged (e.g., internally or with respect to external entities such as other circuits or circuitry) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations. In an example, the software may reside on a machine readable medium, such as a non-transitory machine-readable storage medium. In an example, the software, when executed by the underlying hardware of the component, causes the hardware to perform the specified operations.

Accordingly, such a component encompasses a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which components are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular component at one instance of time and to constitute a different component at a different instance of time.

Machine (e.g., computer system) 800 may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, input device 812 and UI navigation device 814 may be a touch screen display. The machine 800 may additionally include a storage device (e.g., drive unit) 816, a signal generation device 818 (e.g., a speaker), a network interface device 820, and one or more sensors 830, such as a global positioning system (GPS) sensor, compass, accelerometer, or other sensor. The machine 800 may include an output controller 828, such as a serial (e.g., universal serial bus (USB), parallel, or other wired or wireless (e.g., infrared(IR), near field communication (NFC), etc. connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, a machine-readable medium may include a single medium or multiple media (e.g., a centralized or distributed database, and/or associated caches and servers) configured to store the one or more instructions 824. Thus, the term machine readable medium may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions.

Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media (e.g., excluding a transitory propagating signal).

The instructions 824 may further be transmitted or received over a communications network 826 using a transmission medium via the network interface device 820. The machine 800 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks, such as networks implementing the Institute of Electrical and Electronics Engineers (IEEE) 802.11 family of standards known as Wi-Fi®, a Long Term Evolution (LTE) family of standards, a Universal Mobile Telecommunications System (UMTS) family of standards, peer-to-peer (P2P) networks, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. In some examples, the network interface device 820 may wirelessly communicate using Multiple User MIMO techniques.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a communications system adapted for processing messaging, the system comprising: at least one hardware processor; and at least one memory device, including instructions, which when executed, cause the hardware processor to perform operations comprising: receiving a message from a sender, the message addressed to a recipient in a messaging session between the sender and the recipient; predicting a read result of the message based on identified activity of the recipient; selecting a communications transport mechanism for the message, based on the predicted read result of the message; and transmitting the message to the recipient, using the selected communications transport mechanism.

In Example 2, the subject matter of Example 1 includes, wherein the message is received from the sender using a first communications transport mechanism, wherein the message is transmitted to the recipient using a second communications transport mechanism, and wherein the operations further comprise: converting the message for use from a first message format compliant with the first communications transport mechanism to a second message format compliant with the second communications transport mechanism.

In Example 3, the subject matter of Examples 1-2 includes, wherein the communications transport mechanism is selected from among: a first communications transport mechanism provided via a data network, and a second communications transport mechanism provided via a cellular phone data network; and wherein the message includes at least one of: text, audio, or video content.

In Example 4, the subject matter of Examples 1-3 includes, wherein the communications system is a unified communications system allowing communications among multiple types of communications transport mechanisms with multiple types of messages, wherein the unified communications system provides a messaging service for communications among a plurality of users including the sender and the recipient, and wherein the communications transport mechanism is selected from among: an instant messaging service, a chat service, an email service, or a short messaging service (SMS) network service.

In Example 5, the subject matter of Examples 1-4 includes, the operations further comprising: receiving a subsequent message from the sender, the subsequent message addressed to the recipient; predicting an updated read result of the subsequent message based on an updated activity of the recipient and an updated context of interaction between the sender and the recipient, the updated context of the interaction based on the subsequent message and a response to the transmitting of the message; selecting a second communications transport mechanism for the subsequent message, wherein the communications transport mechanism differs from the second communications transport mechanism; and transmitting the subsequent message to the recipient, using the selected second communications transport mechanism.

In Example 6, the subject matter of Examples 1-5 includes, wherein predicting the read result is further based on a context of interaction between the sender and the recipient, with the operations further comprising: receiving information for the context of the interaction between the sender and the recipient, the information indicating priority to conduct a communication between the sender and the recipient; and wherein the context of the interaction is produced from: a defined relationship between the sender and the recipient, a duration of the messaging session, a previous messaging session between the sender and the recipient, or participation in a common event by the sender and the recipient,

In Example 7, the subject matter of Examples 1-6 includes, the operations further comprising: receiving information regarding the activity of the recipient, indicating availability to receive a communication via a plurality of communication transport mechanisms, wherein the selected communications transport mechanism is selected from among the plurality of communication transport mechanisms; and wherein the activity of the recipient is determined from: a scheduled event, participation in a meeting, participation in a call, a working schedule, active operation of a software application, or a state of inactivity on a computing system.

In Example 8, the subject matter of Examples 1-7 includes, wherein the read result corresponds to a likelihood that the message is received and read by the recipient within a predefined time period, and wherein predicting the read result of the message includes: identifying, with a machine learning model, the read result of the message, based on analysis of the activity of the recipient and a context of interaction related to the activity being provided as inputs to the machine learning model; wherein the machine learning model is trained to identify the read result of the message based on responses provided to messages for recipients and messaging sessions having corresponding activities and contexts.

In Example 9, the subject matter of Examples 1-8 includes, wherein selecting the communications transport mechanism is further based on a profile corresponding to the recipient, wherein the profile corresponding to the recipient provides rules for use of the communications transport mechanism.

In Example 10, the subject matter of Examples 1-9 includes, the operations further comprising: identifying a state of receipt for the message at the recipient, to determine that that the message is unread; selecting a second communications transport mechanism for the message, based on characteristics of the message and prior transmission of the message, wherein the communications transport mechanism differs from the second communications transport mechanism; and re-transmitting the message to the recipient, using the selected second communications transport mechanism.

Example 11 is a method for processing messaging with a unified communications service, the method comprising operations performed by a computing device using one or more hardware processors, the operations comprising: receiving a message from a sender, the message addressed to a recipient in a messaging session coordinated by the unified communications service; predicting a read result of the message based on identified activity of the recipient; selecting a communications transport mechanism for the message, based on the predicted read result of the message; and transmitting the message to the recipient, using the selected communications transport mechanism.

In Example 12, the subject matter of Example 11 includes, a configuration where the message is received from the sender using a first communications transport mechanism, wherein the message is transmitted to the recipient using a second communications transport mechanism, as the operations further comprise: converting the message for use from a first format compliant with the first communications transport mechanism to a second format compliant with the second communications transport mechanism.

In Example 13, the subject matter of Examples 11-12 includes, a configuration where predicting the read result is further based on a context of interaction between the sender and the recipient, with the operations further comprising: receiving information regarding the activity of the recipient, indicating availability to receive a communication via a plurality of communication transport mechanisms, wherein the selected communications transport mechanism is selected from among the plurality of communication transport mechanisms; and receiving information for the context of the interaction between the sender and the recipient, the information indicating priority to conduct communications between the sender and the recipient.

In Example 14, the subject matter of Examples 11-13 includes, the operations further comprising: receiving a subsequent message from the sender, the subsequent message addressed to the recipient; predicting an updated read result of the subsequent message based on an updated activity of the recipient and an updated context of interaction between the sender and the recipient, the updated context of the interaction based on the subsequent message and a response to the transmitting of the message; selecting a second communications transport mechanism for the subsequent message, wherein the communications transport mechanism differs from the second communications transport mechanism; and transmitting the subsequent message to the recipient, using the selected second communications transport mechanism.

In Example 15, the subject matter of Examples 11-14 includes, wherein the read result corresponds to a likelihood that the message is received and read by the recipient within a predefined time period, and wherein predicting the read result of the message includes: identifying, with a machine learning model, the read result of the message, based on analysis of the activity of the recipient and a context of interaction related to the activity provided as inputs to the machine learning model; wherein the machine learning model is trained to identify the read result of the message based on responses provided to messages for recipients and messaging sessions having corresponding activities and contexts.

In Example 16, the subject matter of Examples 11-15 includes, a configuration where the communications transport mechanism is selected from among: a first communications transport mechanism provided via a Wi-Fi data network, and a second communications transport mechanism provided via a cellular phone data network; and wherein the message includes at least one of: text, audio, or video content.

In Example 17, the subject matter of Examples 11-15 includes, a configuration where the unified communications system allows communications among multiple types of communications transport mechanisms with multiple types of messages, wherein the unified communications system provides a messaging service for communications among a plurality of users including the sender and the recipient, and wherein the communications transport mechanism is selected from among: an instant messaging service, a chat service, an email service, or a short messaging service (SMS) network service.

Example 18 is a unified messaging service apparatus for processing messaging exchanged between a first entity and a second entity, comprising: means for receiving a message from the first entity, the message addressed to second entity in a messaging session; means for predicting a read result of the message based on identified activity of the second entity and a context of interaction between the first entity and the second entity; means for selecting a communications transport mechanism for the message, based on the predicted read result of the message; and means for transmitting the message to the second entity, using the selected communications transport mechanism.

In Example 19, the subject matter of Example 18 includes, means for translating the message for transmission with another transport mechanism, the message being received from the first entity using a first communications transport mechanism, and the message being transmitted to the second entity using a second communications transport mechanism; and means for reformatting the message, the message being converted from a first format compliant with the first communications transport mechanism to a second format compliant with the second communications transport mechanism.

In Example 20, the subject matter of Examples 18-17 includes, wherein the means for receiving is further adapted for receiving a subsequent message from the first entity, the subsequent message addressed to the second entity; wherein the means for predicting is further adapted for predicting an updated read result of the subsequent message based on an updated activity of the second entity and an updated context of the interaction, the updated context of the interaction based on the subsequent message and a response to the transmitting of the message; wherein the means for selecting the communications transport mechanism is further adapted for selecting a second communications transport mechanism for the subsequent message, wherein the communications transport mechanism differs from the second communications transport mechanism; and wherein the means for transmitting is further adapted for transmitting the subsequent message to the second entity, using the selected second communications transport mechanism.

In Example 21, the subject matter of Examples 18-20 includes, means for identifying information regarding the activity of the second entity, indicating availability to receive a communication via a plurality of communication transport mechanisms, wherein the selected communications transport mechanism is selected from among the plurality of communication transport mechanisms; and means for identifying information for the context of the interaction, the information indicating priority to conduct communications between the first entity and the second entity.

In Example 22, the subject matter of Examples 18-21 includes, means for receiving information regarding an operational status of the second entity to receive a communication via a plurality of communication transport mechanisms, wherein the selecting of the communications transport mechanism for the message is further based on the operational status of the second entity.

In Example 23, the subject matter of Examples 18-21 includes, means configured to cause, perform, or implement any of the structural configurations of Examples 1-17, among client, server, or intermediate network devices.

In Example 24, the subject matter of Examples 18-21 includes, means configured to perform or implement any of the functions, operations, or conditions of Examples 1-17, among client, server, or intermediate network devices.

Example 25 is a machine readable medium (e.g., a computer-readable storage device), provided among one or multiple media, including instructions that, when processed (e.g., loaded, distributed, compiled, packaged, interpreted, executed etc.) by computer hardware, cause processing circuitry to perform operations (e.g., via execution, interpretation, etc.) that implement of any of Examples 1-25.

Example 26 is a system to implement of any of Examples 1-25.

Example 27 is a method to implement of any of Examples 1-25.

What is claimed is:

1. A communications system adapted for processing messaging, the system comprising:
at least one hardware processor; and
at least one memory device, including instructions, which when executed, cause the hardware processor to perform operations comprising:
receiving a message from a sender, the message addressed to a recipient in a messaging session between the sender and the recipient;
predicting a read result of the message based on identified activity of the recipient;
selecting a communications transport mechanism for the message, based on the predicted read result of the message; and
transmitting the message to the recipient, using the selected communications transport mechanism.

2. The system of claim 1, wherein the message is received from the sender using a first communications transport mechanism, wherein the message is transmitted to the recipient using a second communications transport mechanism, and wherein the operations further comprise:
converting the message for use from a first message format compliant with the first communications transport mechanism to a second message format compliant with the second communications transport mechanism.

3. The system of claim 1, wherein the communications transport mechanism is selected from among: a first communications transport mechanism provided via a Wi-Fi data network, and a second communications transport mechanism provided via a cellular phone data network; and
wherein the message includes at least one of: text, audio, or video content.

4. The system of claim 1, wherein the communications system is a unified communications system allowing communications among multiple types of communications transport mechanisms with multiple types of messages,
wherein the unified communications system provides a messaging service for communications among a plurality of users including the sender and the recipient, and
wherein the communications transport mechanism is selected from among: an instant messaging service, a chat service, an email service, or a short messaging service (SMS) network service.

5. The system of claim 1, the operations further comprising:
receiving a subsequent message from the sender, the subsequent message addressed to the recipient;
predicting an updated read result of the subsequent message based on an updated activity of the recipient and an updated context of interaction between the sender and the recipient, the updated context of the interaction based on the subsequent message and a response to the transmitting of the message;
selecting a second communications transport mechanism for the subsequent message, wherein the communications transport mechanism differs from the second communications transport mechanism; and
transmitting the subsequent message to the recipient, using the selected second communications transport mechanism.

6. The system of claim 1, wherein predicting the read result is further based on a context of interaction between the sender and the recipient, with the operations further comprising:
receiving information for the context of the interaction between the sender and the recipient, the information indicating priority to conduct a communication between the sender and the recipient; and
wherein the context of the interaction is produced from: a defined relationship between the sender and the recipient, a duration of the messaging session, a previous messaging session between the sender and the recipient, or participation in a common event by the sender and the recipient.

7. The system of claim 1, the operations further comprising:
receiving information regarding the activity of the recipient, indicating availability to receive a communication via a plurality of communication transport mechanisms, wherein the selected communications transport mechanism is selected from among the plurality of communication transport mechanisms; and
wherein the activity of the recipient is determined from: a scheduled event, participation in a meeting, participation in a call, a working schedule, active operation of a software application, or a state of inactivity on a computing system.

8. The system of claim 1, wherein the read result corresponds to a likelihood that the message is received and read by the recipient within a predefined time period, and wherein predicting the read result of the message includes:
identifying, with a machine learning model, the read result of the message, based on analysis of the activity of the recipient and a context of interaction related to the activity being provided as inputs to the machine learning model;
wherein the machine learning model is trained to identify the read result of the message based on responses provided to messages for recipients and messaging sessions having corresponding activities and contexts.

9. The system of claim 1, wherein selecting the communications transport mechanism is further based on a profile corresponding to the recipient, wherein the profile corresponding to the recipient provides rules for use of the communications transport mechanism.

10. The system of claim 1, the operations further comprising:
identifying a state of receipt for the message at the recipient, to determine that that the message is unread;
selecting a second communications transport mechanism for the message, based on characteristics of the message and prior transmission of the message, wherein the communications transport mechanism differs from the second communications transport mechanism; and
re-transmitting the message to the recipient, using the selected second communications transport mechanism.

11. A method for processing messaging with a unified communications service, the method comprising operations performed by a computing device using one or more hardware processors, the operations comprising:
receiving a message from a sender, the message addressed to a recipient in a messaging session coordinated by the unified communications service;
predicting a read result of the message based on identified activity of the recipient;
selecting a communications transport mechanism for the message, based on the predicted read result of the message; and
transmitting the message to the recipient, using the selected communications transport mechanism.

12. The method of claim 11, wherein the message is received from the sender using a first communications transport mechanism, wherein the message is transmitted to the recipient using a second communications transport mechanism, and wherein the operations further comprise:
converting the message for use from a first format compliant with the first communications transport mechanism to a second format compliant with the second communications transport mechanism.

13. The method of claim 11, wherein predicting the read result is further based on a context of interaction between the sender and the recipient, with the operations further comprising:
receiving information regarding the activity of the recipient, indicating availability to receive a communication via a plurality of communication transport mechanisms, wherein the selected communications transport mechanism is selected from among the plurality of communication transport, mechanisms; and receiving information for the context of the interaction between the sender and the recipient, the information indicating priority to conduct communications between the sender and the recipient.

14. The method of claim 11, the operations further comprising:
receiving a subsequent message from the sender, the subsequent message addressed to the recipient;
predicting an updated read result of the subsequent message based on an updated activity of the recipient and an updated context of interaction between the sender and the recipient, the updated context of the interaction based on the subsequent message and a response to the transmitting of the message;
selecting a second communications transport mechanism for the subsequent message, wherein the communications transport mechanism differs from the second communications transport mechanism; and
transmitting the subsequent message to the recipient, using the selected second communications transport mechanism.

15. The method of claim 11, wherein the read result corresponds to a likelihood that the message is received and read by the recipient within a predefined time period, and wherein predicting the read result of the message includes:
identifying, with a machine learning model, the read result of the message, based on analysis of the activity of the recipient and a context of interaction related to the activity provided as inputs to the machine learning model;
wherein the machine learning model is trained to identify the read result of the message based on responses provided to messages for recipients and messaging sessions having corresponding activities and contexts.

16. A unified messaging service apparatus for processing messaging exchanged between a first entity and a second entity, comprising:
means for receiving a message from the first entity, the message addressed to second entity in a messaging session;
means for predicting a read result of the message based on identified activity of the second entity and a context of interaction between the first entity and the second entity;
means for selecting a communications transport mechanism for the message, based on the predicted read result of the message, and
means for transmitting the message to the second entity, using the selected communications transport mechanism.

17. The apparatus of claim 16, further comprising:
means for translating the message for transmission with another transport mechanism, the message being received from the first entity using a first communications transport mechanism, and the message being transmitted to the second entity using a second communications transport mechanism; and
means for reformatting the message, the message being converted from a first format compliant with the first communications transport mechanism to a second format compliant with the second communications transport mechanism.

18. The apparatus of claim 16,
wherein the means for receiving is further adapted for receiving a subsequent message from the first entity, the subsequent message addressed to the second entity;
wherein the means for predicting is further adapted for predicting an updated read result of the subsequent message based on an updated activity of the second entity and an updated context of the interaction, the updated context of the interaction based on the subsequent message and a response to the transmitting of the message;
wherein the means for selecting the communications transport mechanism is further adapted for selecting a second communications transport mechanism for the subsequent message, wherein the communications transport mechanism differs from the second communications transport mechanism, and
wherein the means for transmitting is further adapted for transmitting the subsequent message to the second entity, using the selected second communications transport mechanism.

19. The apparatus of claim 16, further comprising:
means for identifying information regarding the activity of the second entity, indicating availability to receive a communication via a plurality of communication transport mechanisms, wherein the selected communications transport mechanism is selected from among the plurality of communication transport mechanisms; and
means for identifying information for the context of the interaction, the information indicating priority to conduct communications between the first entity and the second entity.

20. The apparatus of claim 16, further comprising:
means for receiving information regarding an operational status of the second entity to receive a communication via a plurality of communication transport mechanisms, wherein the selecting of the communications transport mechanism for the message is further based on the operational status of the second entity.
